(19) United States
(12) Patent Application Publication
(10) Pub. No.: US 2013/0113420 A1
(43) Pub. Date: May 9, 2013

(54) Universal Station for Organizing and Charging Multiple Electronic Devices

(71) Applicant: John L. Majoris, JR., Annandale, NJ (US)

(72) Inventor: John L. Majoris, JR., Annandale, NJ (US)

(21) Appl. No.: 13/724,458

(22) Filed: Dec. 21, 2012

Related U.S. Application Data
(60) Provisional application No. 61/708,704, filed on Oct. 2, 2012.

(51) Int. Cl. H02J 7/00

(52) U.S. Cl. CPC H02J 7/0044; H02J 7/0052
USPC 320/107; 320/137

(57) ABSTRACT

A universal organizing and charging station apparatus an related method of use for organizing and charging electronic devices, comprising: a bottom surface plane; a substantially vertical rear surface; a top surface which is substantially horizontal running from front to back and side to side; a slanted front surface connecting a front of the bottom surface with a front of the top surface; left and right side surface planes; a plurality of charging cable slots originating on the rear surface, running vertically up the rear surface, continuing over the top surface from back to front, continuing down at least part of the slanted front surface, and terminating on the slanted front surface; a plurality of charger head apertures, one associated with each the slot, disposed upon the rear surface in continuous connection with the associated slot; and an interior access opening between an exterior and interior of the apparatus.

### CROSS REFERENCE TO RELATED APPLICATIONS

This application claims priority benefit of pending provisional application U.S. 61/708,704 filed Oct. 2, 2012, which is hereby incorporated by reference.

### BACKGROUND OF THE INVENTION

A 2011 Pew Research study estimated that adults in the United States own an average of four distinct portable electronic devices including mobile phones, music devices, cameras, compact computers, and similar devices. It is estimated that by 2015 this will rise to about half a dozen devices per adult, and of course, many people today already have many more devices than this average. Children and teens often have even more devices than their parents, so for an average family of four, one may expect to find anywhere from a dozen to two dozen such devices in a given household.

Because these devices are portable, they need to be regularly charged, and of course, it is very easy to lose or misplace these devices or have them run out of power if the user does not establish a careful discipline for organizing and charging these devices. Furthermore, even when one is well-organized, the tangle of wires that are used to charge these devices is unsightly, and for a larger number of devices, it can be maddening to sort through the wires in order to connect the right device with the right charging heads. Indeed, if a wrong device is connected to the wrong charging head, such misconnection can actually short out and destroy an electronic device. So it is very important to make sure that the right head is being plugged into the right electronic device.

Additionally, an individual will often have multiple devices of different sizes, with different configurations, from different manufacturers, that use different charging devices and charging head interfaces. Organizing all of these for charging, in general, is simply quite a challenge.

While the prior art reveals some organizing devices such as U.S. Pat. No. 6,860,764 for a modular appliance, as well as a variety of so-called “docking stations” to facilitate connecting multiple peripheral devices to a computer, the prior art does not appear to reveal any satisfactory solutions to this problem of charging and organizing multiple, diverse electronic devices.

Perhaps the best device to date is that of U.S. Pat. No. 7,201,611, which is a “Docking System to Attach and Retain Multiple Electronic Devices Simultaneously on a Surface.” Yet this docking system too has a number of defects that warrant improvement. First, as is easily seen from U.S. Pat. No. 7,201,611, a substantial portion of cable 38 runs externally to the docking system, and for multiple devices, this will still prove to be unsightly. If all nine of the illustrated slots were to be used, there would be nine wires running along the lower front surface, entangling with one another in full view. Second, the connector 26 must “be frictionally secured within the respective slot 22, the connector 26 having a pair of opposing sidewalls 36 abutting the adjacent sidewalls of the slot 22 to provide a secure setting therewithin” and this securing requires the use of connector that fits within the slot such as “iTips™ manufactured by Mobility Electronics, Inc. of Scottsdale, Ariz., the assignee of” U.S. Pat. No. 7,201,611. This limits flexibility by requiring connectors (apparently proprietary) which frictionally fit or can be fitted to the slots 22. Third, each electronic device must be rested in a distinct, fixed location determined by the slots 22, limiting flexibility. Fourth, very importantly, when a given electronic device in not being used, the cables 38 and electrical interfaces 28 and associated hardware still remain visible, that is, someone looking at the docking system would see nine unconnected wires and charging interfaces, which continues to be unsightly. Fifth, this docking system is limited to small electronic devices such as phones and iPods, etc., and would not be able to accommodate a mix of medium devices, and larger devices such as iPads, together with the smaller devices. Nor is there any apparent way to simply scale up this device to readily mix device sizes. Sixth, U.S. Pat. No. 7,201,611 does not allow the user to turn devices on their side, which in turn preventing the user from seeing the charge indicator light and from using the device in “landscape” rather than “portrait” mode. Seventh, U.S. Pat. No. 7,201,611 does not appear to enable a device to have a data connection to a computer, while it is being charged.

Consequently, it would be very desirable to have available a charging station and associated method of use which allows multiple electronic devices of different types with multiple sizes and charging interfaces, from a variety of manufacturers, to all be charged and organized without the unsightly appearance of multiple wires and charging heads.

It would also be desirable to have a charging station and associated method of use wherein when an electronic device is not charging, its wiring and charging head may be completely hidden from view. Specifically, while it is virtually impossible to maintain wiring for multiple devices without some tangling, whatever tangling does occur should be completely hidden from view, in contrast to U.S. Pat. No. 7,201,611 in which some of the tangle of wires from multiple devices—although not illustrated because only one device is shown in the drawings—will inevitably be in view beneath elongated support member 20.

It would further be desirable to enable the user to achieve maximum flexibility to determine how devices are to be laid out on the charging station, without having the charging heads for these devices restricted to distinct, fixed positions.

It would further be desirable to omit the requirement for any frictional or proprietary fittings for securing the charging connector.

Finally, it would be desirable to have a charging station and associated method of use wherein the user can use the electronic devices while they are charging on the station by establishing a data connection between these devices and a computer, simultaneously with the charging of these devices.

All of these benefits, and others, are provided by the invention disclosed here.

### SUMMARY OF THE INVENTION

A universal organizing and charging station apparatus and related method of use for organizing and charging electronic devices, comprising: a bottom surface plane which is substantially horizontal running from front to back and side to side, with a bottom surface depth thereof as measured from front to back; a substantially vertical rear surface; a top surface which is substantially horizontal running from front to back and side to side, with a top surface depth thereof as measured from front to back, wherein the top surface depth is smaller than the bottom surface depth; a slanted front surface connecting a front of the bottom surface with a front of the top surface, wherein the front surface is so-slanted because the top surface depth is smaller than the bottom surface depth and the rear surface is substantially vertical; left and right side surface planes; the rear, top and front surfaces, and the bottom and left and right side surface planes, defining an interior of the station; a plurality of charging cable slots originating on the rear surface, running vertically up the rear surface, continuing over the top surface from back to front, continuing down at least part of the slanted front surface, and terminating on the slanted front surface, for sliding an electrical connector wire of the charging cable therethrough; a plurality of charger head apertures, one associated with each the slot, disposed upon the rear surface in continuous connection with the associated slot, for threading a charging head therethrough; and an interior access opening between an exterior and the interior of the station, for setting up a wiring configuration of the station.

### BRIEF DESCRIPTION OF THE DRAWINGS

The features of the invention believed to be novel are set forth in the appended claims. The invention, however, together with further objects and advantages thereof, may best be understood by reference to the following description taken in conjunction with the accompanying drawing(s) summarized below.

FIG. 1 illustrates a top-front-left perspective view of an organizing and charging station for electronic equipment in accordance with a first preferred embodiment of the invention.

FIG. 2 is a left-side plan view illustrating the organizing and charging station of FIG. 1.

FIG. 3 is a back-side plan view illustrating the organizing and charging station of FIG. 1.

FIG. 4 depicts an illustrative, non-limiting, exemplary charging cable of a type that is well-known in the art, for charging an electronic device.

FIG. 5 is a rear perspective view illustrating a step of setting up the charging station with the charging cables used to charge electronic devices wherein the cables are threaded into charging cable slot and connected to a power source, after the user has decided how to lay out the devices on the station.

FIG. 6 illustrates in top-front-left perspective view, a step of setting up the charging station with the charging cables used to charge electronic devices, wherein the cables are slid through the slots into position for attaching electronic devices thereto.

FIG. 7 is a top-front-left perspective view illustrating the charging station in use to organize and charge (and optionally use via a data connection to a computer) an unrestricted variety of multiple electronic devices.

FIG. 8 is a top-rear-right perspective view of the charging station when all of the electronic devices have been removed and the cables and cable heads are in a parked storage position.

FIG. 9 illustrates a plan view of an optional access opening cover used to cover the access opening through which the wiring is set up to use the organizing and charging station.

FIG. 10 is a top-front-left perspective view illustrating a variation of the station of FIG. 1 comprising one or more extra-wide cable slots, heat dissipation ribs, and a top surface peripheral lip, each of which is optional, separately or in any combination.

FIG. 11 is a top-front-left perspective view illustrating a variation of the station of FIG. 1 comprising one or more electronic device slots.

FIG. 12 is a top-front-left perspective view illustrating how the electronic device slots of FIG. 11 may be used to store larger electronic devices in a “folio” configuration.

### DETAILED DESCRIPTION

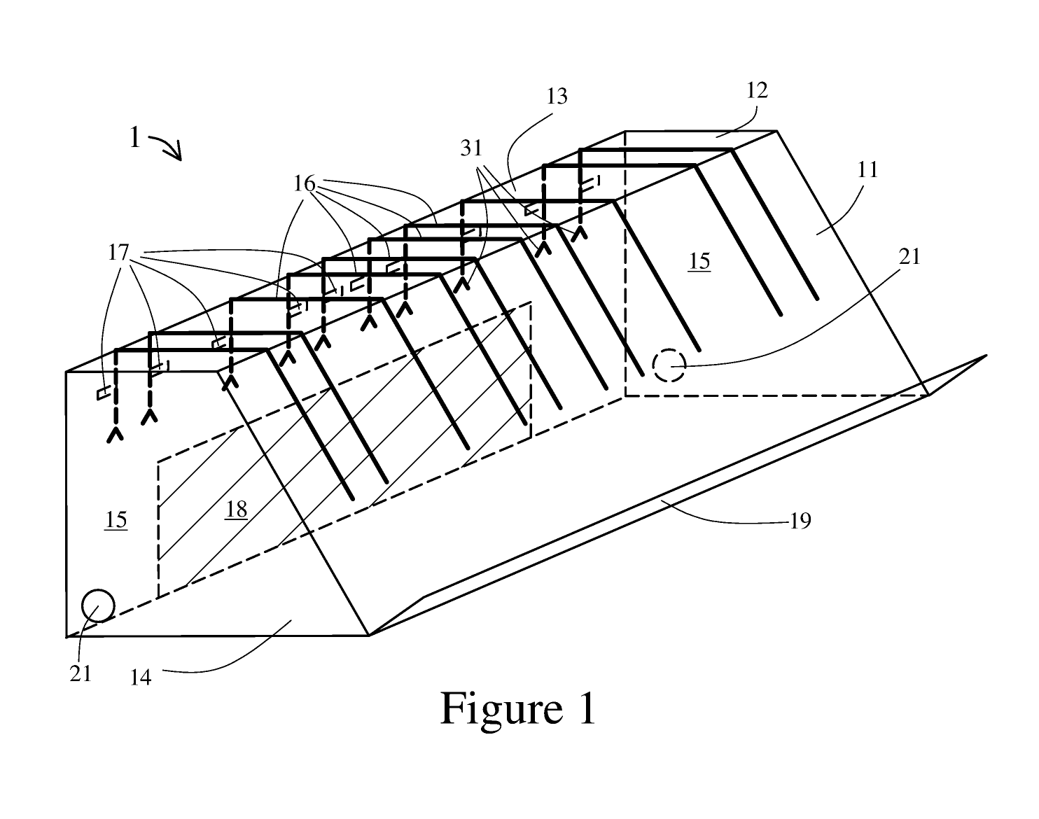

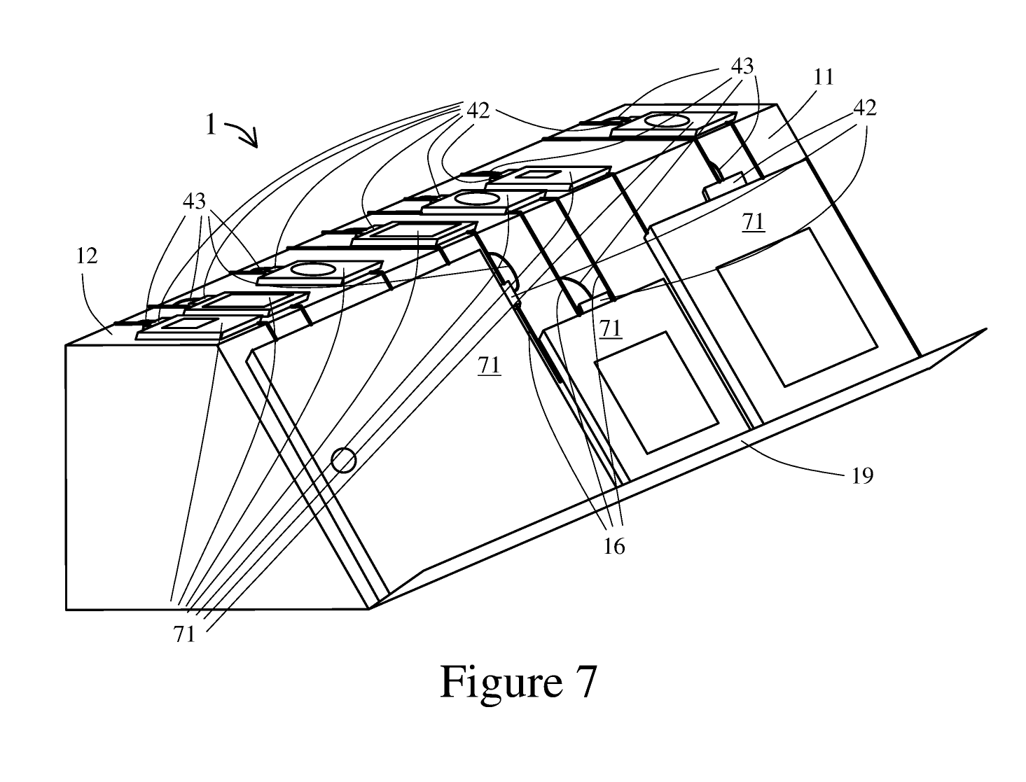

FIG. 1 illustrates a top-front-left perspective view of a universal organizing and charging station 1 for multiple portable electronic devices (71 in FIG. 7) in accordance with a first preferred embodiment of the invention. Aspects of the bottom 14, rear 13 and right 15 sides which are hidden in this view, are shown in dashed lines. Similar dashed lines will be used throughout this disclosure to show elements hidden from external view. The station 1 body comprises a front surface 11, a top surface 12, a rear surface 13, a bottom surface 14 and two side surfaces 15. A plurality of charging cable slots 16 are cut into the station body, running continuously over a portion of front surface 11, the entirety of top surface 12, and a portion of rear surface 13, as illustrated. Specifically, this plurality of charging cable slots 16 originate on rear surface 13, run vertically up rear surface 13, continue over top surface 12 from back to front, continue down at least part of the front surface 11, and terminate on the front surface 11.

Optionally, one or more of the slots 16 terminate in a cable parking receptacle 31 configured in one possible variation as an inverted “Y,” see also, FIG. 3. A plurality of charger head apertures 17, one associated with each slot 16, are disposed upon the rear surface 13 in continuous connection with the associated slot 16. That is, any given slot 16 taken in combination with its head aperture 17 forms a continuous and connected opening through the station body, as illustrated. An interior access opening 18 shown in FIGS. 1 and 3 with diagonally-hashed lines situated on the rear surface 13 provides a user with access between an exterior of the station 1, and the interior volume defined by the bottom 14, rear 13, top 12, front 11 and two side 15 surfaces.

While it is preferred for interior access opening 18 to be situated on rear surface 13 as illustrated, this is non-limiting. While less-preferred, interior access opening 18 may be situated on either of the side surfaces 15, or on bottom surface 14. Alternatively, one of the side surfaces or the bottom surface may be omitted entirely. In the circumstance where one surface is omitted entirely, the plane of what is illustrated as a surface in the drawings simply is an open plane which serves as interior access opening 18. In general, we shall use the term “surface plane” to refer to a surface which may be either a material substance or an open geometric plane with little or no material substance.

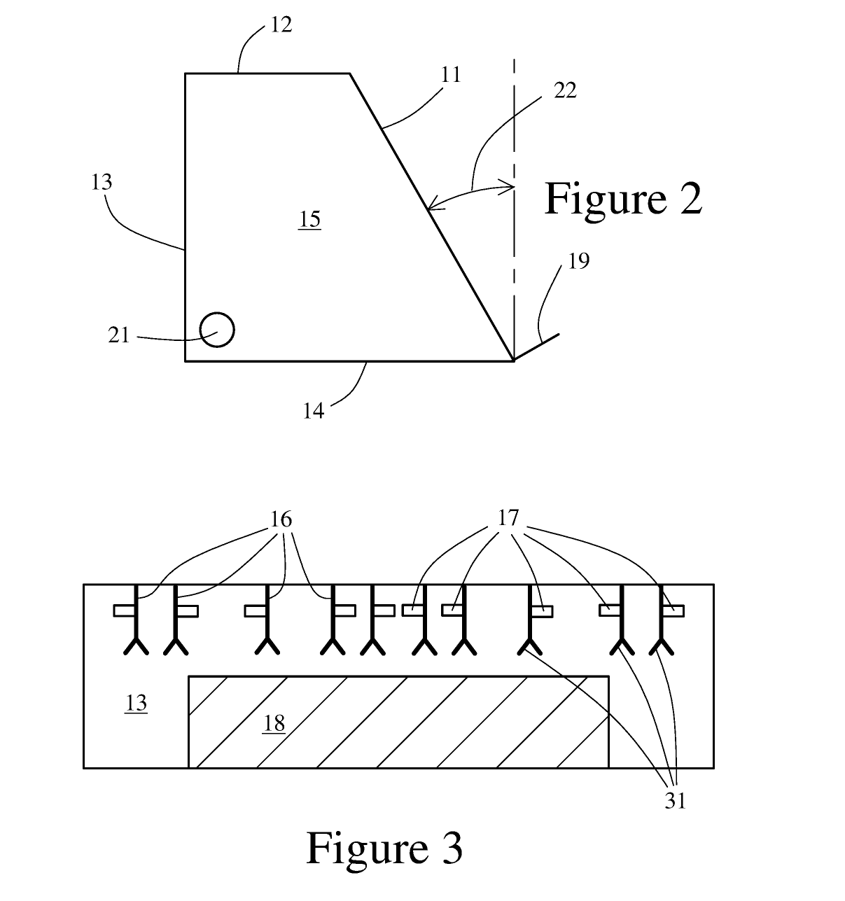

Finally, there is a front support shelf 19 affixed to charging station 1 along all or part of the lower length of front surface 11 as illustrated. It will be seen from both FIGS. 1 and 2 that front surface 11 is slanted. The front support shelf 19 is substantially complementary-angled relative to slanted front surface 11, which is to say, it is angled at about 90 degrees in relation to front surface 11, as illustrated. However, this relative angle may vary from 60 degrees to 120 degrees, though preferably in the range of 70 to 110 degrees, and an even more preferably 80 to 100 degrees. One or both of the side surfaces 15 may also optionally comprise a power cord aperture 21, also as shown.

Station 1 provides a single location (countertop, tabletop, desktop or wall mount) to charge all types of smartphones, cellphones, digital cameras, MP3 players, tablets, notebooks, laptops, and external hard drives, etc. in a neat and orderly fashion while hiding the electrical and charging cables inside of the station unit. A single station can handle, for example, not limitation, a combination of 2 iPads, or 1 iPad and 2 smaller tablets on the front slanted surface 11 with support shelf 19, and up to 10 smartphones, cellphones, digital cameras, or MP3 players on top surface 12. While measurements may be varied, in a preferred embodiment station 1 is 24″ wide by 8″ deep by 7″ high (not to preclude similar stations with metric units of measure). A “mini” version of this station is 12″ wide by 8″ deep by 7″ high, and essentially comprises the left or right “half” of the station 1 illustrated in FIG. 1, with interior access opening 18 suitably resituated. Station 1 is preferably made of plastic or similar material with appropriate durability and rigidity.

Referring to the side view of FIG. 2, and recognizing that these dimensions can be altered or adjusted within the scope of this disclosure and its associated claims, the top surface 12 is preferably 3.5″ to 4.5″ in depth, with a preferred 4″ depth. So if the overall depth as measured along bottom surface 14 is 8″ and the height as measured along rear surface 13 is 7″ and the depth as measured along top surface 12 is 4″, the slant angle of front surface 11 will be uniquely determined by geometric considerations. Based on the particular preferred but non-limiting dimensions just described, the slant angle 22 of slanted front surface 11 is about 30 degrees from vertical. However, the dimensions of station 1 along surfaces 11, 12, 13 and 14 may be chosen so as to render slant angle 22 to be anywhere from 15 to 45 degrees. Specifically, slant angle 22 is at most 45 degrees from vertical, and is at least 15 degrees from vertical. It is preferred that slant angle 22 be at most 40 degrees from vertical and at least 20 degrees from vertical; more preferred that it be at most 25 degrees from vertical and at least 25 degrees from vertical; and most preferred that it be approximately 30 degrees from vertical. The front support shelf 19 is then fixed, preferably at an approximate 90 degree angle relative to front surface 11, within the ranges previously noted. If station 1 has the approximate dimensions set forth above, then in an exemplary, non-limiting embodiment, referring back to FIG. 1, a forward end of each slot 16 will be situated at about 3″ above the bottom of front slanted surface 11 where front slanted surface 11 meets support shelf 19. Each slot will then run uninterrupted, continuously across the top surface 12 and down the rear surface 13. A rear end of each slot terminates on rear surface 13 about 2″ down from the juncture between top surface 12 and rear surface 13, all as illustrated, and may terminate instead in the optional cable parking receptacles 31 as noted earlier. Again, these dimensions and lengths are exemplary, not mandatory, and are meant to be illustrative without limiting this disclosure or the claims.

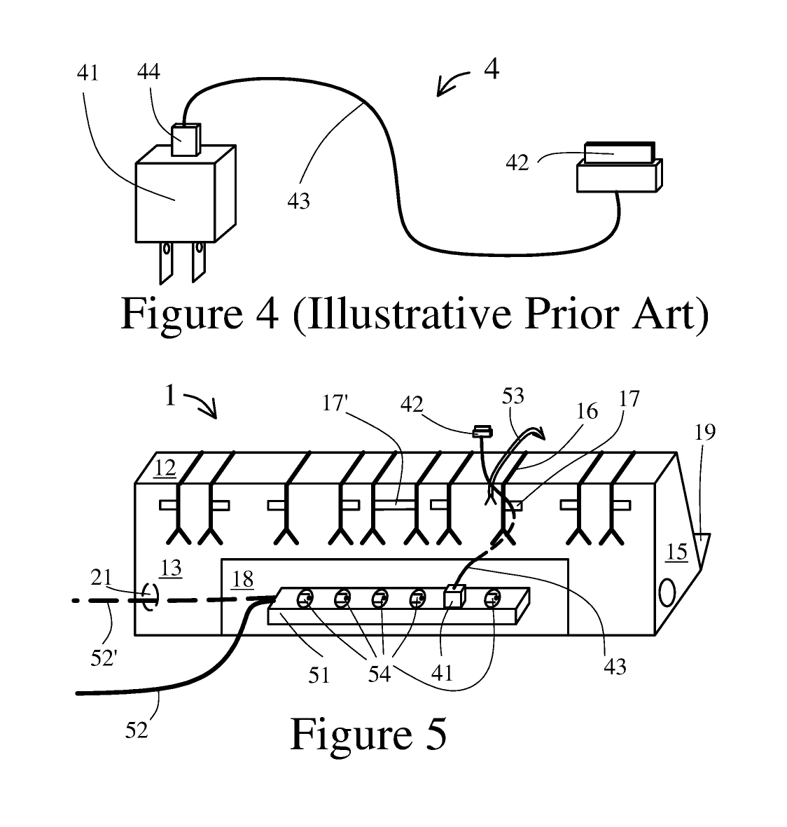

Given that charging cables (see 4 and 43 in FIG. 4) for most common electronic devices are approximately ⅛″ in diameter, the cable slots 16 are preferably 3/16″ in width. The cable slots 16 are made slightly larger so that charging cables can readily slide within cable slots 16. It is preferred, though not required, that these slots 16 comprise a compressible retentive and protective material, such as but not limited to a firm sponge or rubber material, that can press gently against a cable to help it retain its position with the slot 16, yet at the same time yield to the cable width so as to allow the cable to manually be slid forward or backward in a slot. This also helps protect the cable from damage such as cutting by contact with and movement against the edges of the slots 16. This helps ensure that any smartphone, cellphone, digital camera, MP3 player and tablet device with a standard size manufacturer supplied ⅛ ″charging cable can be charged in a neat and orderly fashion using station 1.

Referring to FIGS. 3 and 5, interior access opening 18 is used to insert one or more power aggregation devices 51 (only one is illustrated in FIG. 5 to avoid drawing clutter) such as a power strip(s) or a USB hub(s) or similar device. These power aggregation devices 51 comprise a plurality of outlets 54 (which may be power-only outlets, or USB slots providing both power and digital data connectivity) which are placed by the user into the interior of the body of station 1. Alternatively, station 1 may be fabricated so as to integrally comprise power aggregation device (s) 51 as part and parcel thereof. In either case (user provided or integral to the manufactured station 1), a plurality of power or power-plus-data outlets 54 are thus provided within the interior of the body of station 1, with a power and/or data feed cord(s) 52, 52′ emanating from station 1 that may then be plugged into a standard power outlet or other power source (such as a computer USB port). The feed cord 52 illustrated in FIG. 5 is for a cord that exits through interior access opening 18; while the feed cord 52′ is a cord that runs through the power/data cord aperture 21, all as illustrated. The benefit of this latter 52′ configuration is that it avoids having the power/data cord exit through interior access opening 18, and thus allows the rear surface 13 of station 1 to be pushed flush against a wall and all the wiring in the interior of station 1 to be hidden from view and/or allows interior access opening 18 to be covered with the access opening cover 91 of FIG. 9.

Referring to FIG. 4, each of the electronic devices (71 in FIG. 7) that the user plans to charge with station 1 will of course have associated therewith, a charging cable 4 comprising a plug head 41 at one end, a charging head 42 at the other end, and an electrical connector wire 43 in between, as illustrated in generic, non-limiting form in FIG. 4. It is noted that many modern electronic devices now come with a USB charger cable which can be plugged into a conventional power outlet via a plug head 41, or into a USB hub, or into a USB port on a computer. Thus, FIG. 4 also illustrates a USB connector 44 that inserts into the plug head 41 in a manner well-known in the art. For ordinary, conventional plug heads, it is understood that 41 and 44 are one and the same, i.e., 41 and 44 are not separable. But for USB connectors, 41 and 44 do, of course, separate. And, of course, a USB connector is configured to simultaneously supply power and a digital data connection. While reference is made in this disclosure to USB interfaces and connectors, it is recognized that the computer industry is constantly evolving and that there are other interfaces besides USB interfaces which also combine power and data. Thus, other combined power and data interfaces beside those known presently as “USB” which may exist or may evolve over time are to be regarded as suitable for use within the scope of this disclosure and its associated claims.

To set up station 1 for customized use with the particular electronic devices 71 that a user wishes to charge in a sightly, organized fashion, the user will first plan the layout of where and with what orientation the user wishes to ultimately situate each electronic device 71 upon the station 1. Preferably this will be achieved by placing each electronic device in its intended location at its intended orientation (see FIG. 7), as a guide for proceeding with the wiring setup step to now be described.

Referring again to FIG. 5, to set up the wiring configuration relative to where the electronic devices 71 are to be situated, the user first moves the charging head 42 for each such device into the inside of station 1 via interior access opening 18. The user next passes (threads) the charging head 42 through one of the charger head apertures 17, from the inside (interior) to the outside (exterior) of station 1, as illustrated. It will be appreciated that the charger head apertures 17 will need to be of sufficient length and width to accommodate the passage of charging heads 42 therethrough. Therefore, a preferred dimension for the charger head apertures 17 is 1.5″ in length by ⅜″ in width, which will accommodate virtually all commercially-utilized charging heads 42. Optionally, as shown in 17′ of FIG. 5, one may configure one or more of the charger head apertures 17 such that they connect two adjacent slots together to provide extra room for passing charging heads 42 therethrough, thereby accommodating unusually-large charging heads, and to also increase flexibility by allowing a charging cable 4 to be moved from one slot 16 to another without re-threading.

Thus, each cable slot 16 has (or shares) one charger head aperture 17 in the back 13 of the station 1 integrally continuously connected with said cable slot 16. Thus, once a charging head 42 has been passed through a charger head aperture 17, it becomes possible to slide the electrical connector wire 43 through the associated cable slot 16 from the back 13 to the top 12 (and optionally for an electronic device to be stored in the front surface) to the front 11 of the charging station 1, as illustrated by the directional arrow 53.

Additionally, the plug section 41 (which may simply be the USB connector 44 in the event the power aggregation device 51 is a USB hub) of charging cable 4 is plugged in to one of the plurality of power outlets 54 within the interior of the body of station 1. Once the outlet 54 is powered, the charging head 42 will also become powered so as to be able to charge the associated electronic device 71 when that is plugged in. All of this setup is done through the rear 13 of the station 1 via interior access opening 18, so that once setup is complete, the rear 13 of the station 1 may be moved against a wall, or via optional wall mounts (not illustrated but well-known in the art) hung on a wall, so as to hide all the wiring and wiring connections from view. Additionally, or alternatively, interior access opening 18 may be covered using the access opening cover 91 of FIG. 9. This is why the power cord configuration 52′ is preferred over 52.

As noted earlier, while it is preferred that interior access opening 18 between the exterior and interior of the station 1 be situated on the rear surface 13, an interior access opening 18 utilizing the bottom 14 or one of the side 15 surfaces or surface planes is also regarded to be within the scope of this disclosure and its associated claims.

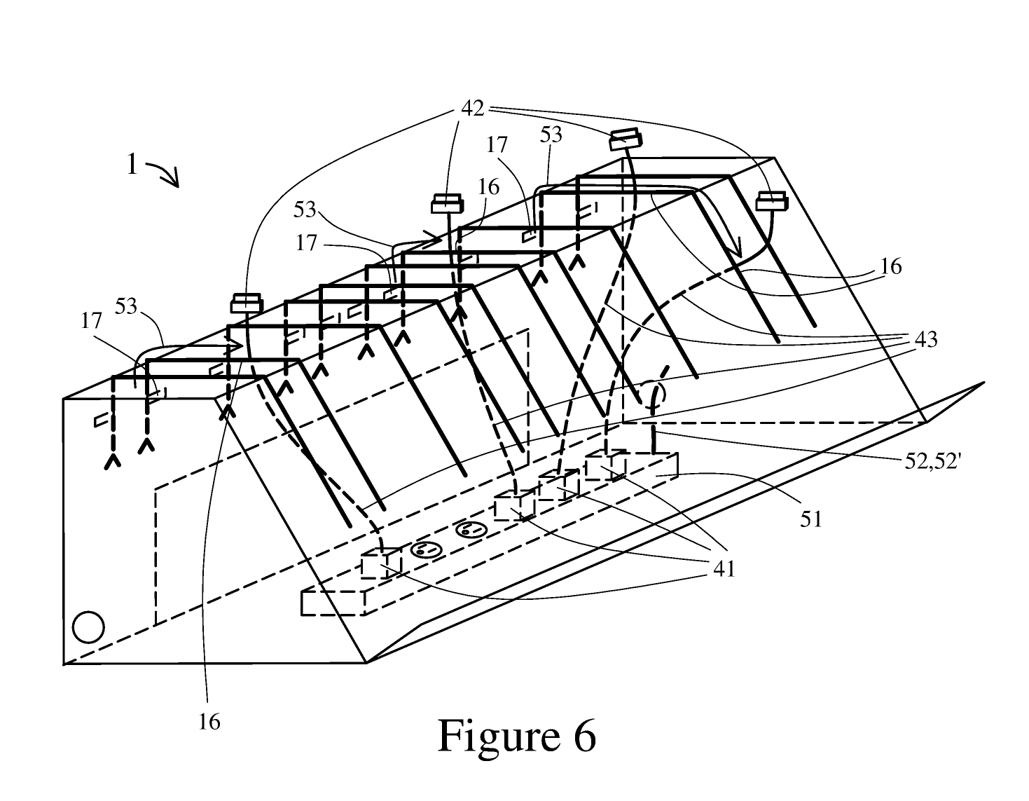

Turning to FIG. 6, once the charging cables 4 for multiple devices have been threaded into the slots 16 as illustrated in FIG. 5, the charging heads 42 can then be slid forward and backward over the full length of the cable slots 16 into which they are threaded, while minimizing cable view because most of the cable lengths reside in the interior of station 1. FIG. 6 illustrates four (4) cables 4 in total threaded into three (3) different slots 16. Particularly, we see two (2) cables 4 threaded into the slot 16 which is second from the upper right of FIG. 6, one of which has its charging heads 42 slid forward to protrude from the top surface 12, and the other of which is slid even further forward to protrude from the slanted front surface 11. The other two cables 4 in the other two slots 16 both have their charging heads 42 slid forward to protrude from the top surface 12. All of this is illustrative, not limiting, and the user can set this up in any way the user chooses, subject only available space on the station 1.

In an important variation of the invention introduced earlier, the power aggregation device 51 may be a USB hub rather than an ordinary power strip, as already noted. And, of course, USB hubs may themselves be connected to a USB port on a computer, as is well known. So in this variation, feed cord 52, 52′ is the power and data cord belonging to the USB hub, and its distal end (not shown) may then be plugged into a USB port (or like computer port which combines power and data) on a computer for feeding both power and data connectivity to the electronic device 71. In this variation, not only may the electronic devices 71 while resting on the station 1 then be charged via power from the computer rather than via power from a wall outlet, but they will also enjoy a digital data connection to the computer and so be fully interoperable with the computer.

Once all of this setup is completed, charging station 1 may then be used to charge and organize multiple portable electronic devices 71 of any size and configuration, and from any manufacturer, as illustrated in FIG. 7. The user simply draws the charging head 42 forward or backward through the slot 16 into which it is threaded, into a location where is can be easily plugged into the charging port of is associated electronic device 71, plugs the head 42 into the device 71, and rests the device 71 against the charging station 1. When all of this is done, the electronic devices 71 rest neatly organized upon the font and top surfaces of charging station 1, they are all plugged in and charging, and all of the unsightly wiring for these devices is completely hidden within the interior of charging station 1, with the exception of approximately one or at most two inches of wire 43 at the very end, immediately proximate charging heads 42.

In addition, by virtue of the USB or like-connections discussed earlier, it is possible not only to charge these electronic devices 71 such as external hard drives, tablets and smart phones, but to actually run/use them, simultaneously with their being connected to charging station 1. One may also run/use tablets and smart phones while they are lying on their sides, charging, on the front slanted surface 11.

As seen in FIG. 7, the slated front surface 11 may be used for larger devices such as iPads, of varying sizes, and the top surface 12 provides space for smaller devices such as a variety of portable phones, iPods, etc. Specifically, this station 1 can be used to simultaneously charge all manufacturers' cell phones, including smart and dumb phones, including but not limited to: Motorola, Apple, Samsung, Nokia, LG, Sony, Blackberry, etc. More specifically, this station may be used, for example, not limitation, with the following exemplary devices: Small tablets, (5-6.9 inches) such as the Samsung Galaxy Note. Medium tablets (7 to 8.9 inches) such as the Amazon Kindle Fire, Barnes and Noble Nook, Googles Asus Nexus 7, HTC Flyer, Apple's Mini iPad. Large tablets (9-10 inches) such as the Apple iPad, Motorola Droid XYboard, Samsung Galaxy Note 10.1, Toshiba Excite 10LE., Lenovo Idea Tab 52110. Extra Large Tablets (11″+) such as the Toshiba Excite 13, Samsung Series 7, Acer Iconia W700, Microsoft Surface Win RT. This listing of devices is by no means limiting or exhaustive but rather, illustrates clearly how the use of this station 1 is unrestricted with regard to a) device 71 manufacturer, b) device 71 size, c) charging cable 43 size (diameter) d) charging head 42 type, and e) whether the connector charging cables 4 are for power only, or power plus data as exemplified by a USB connector.

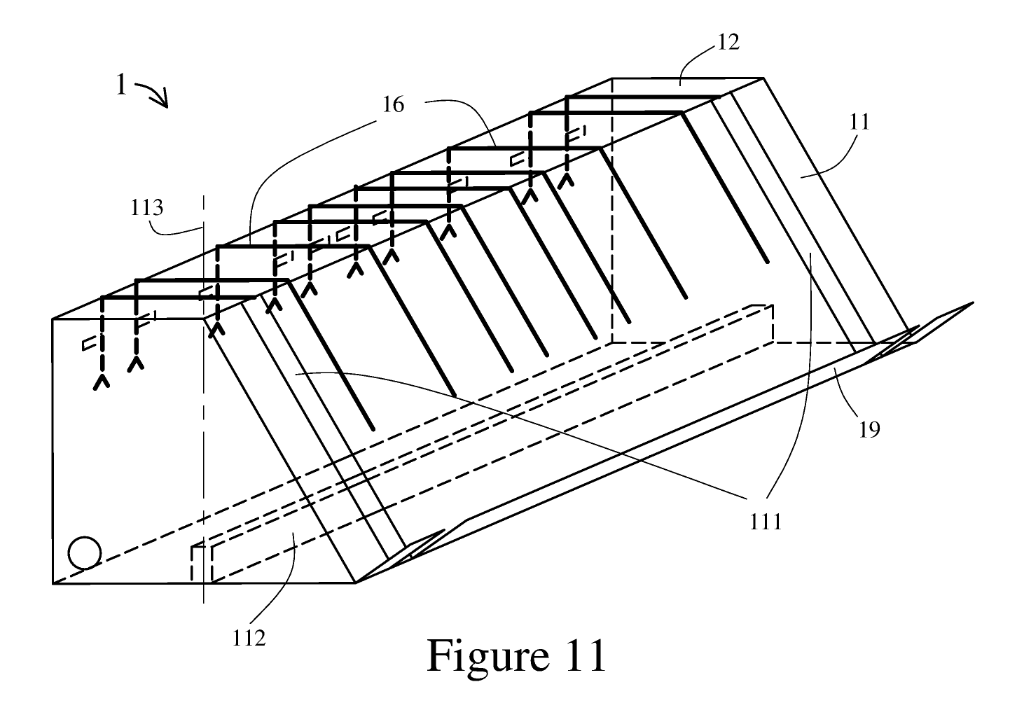

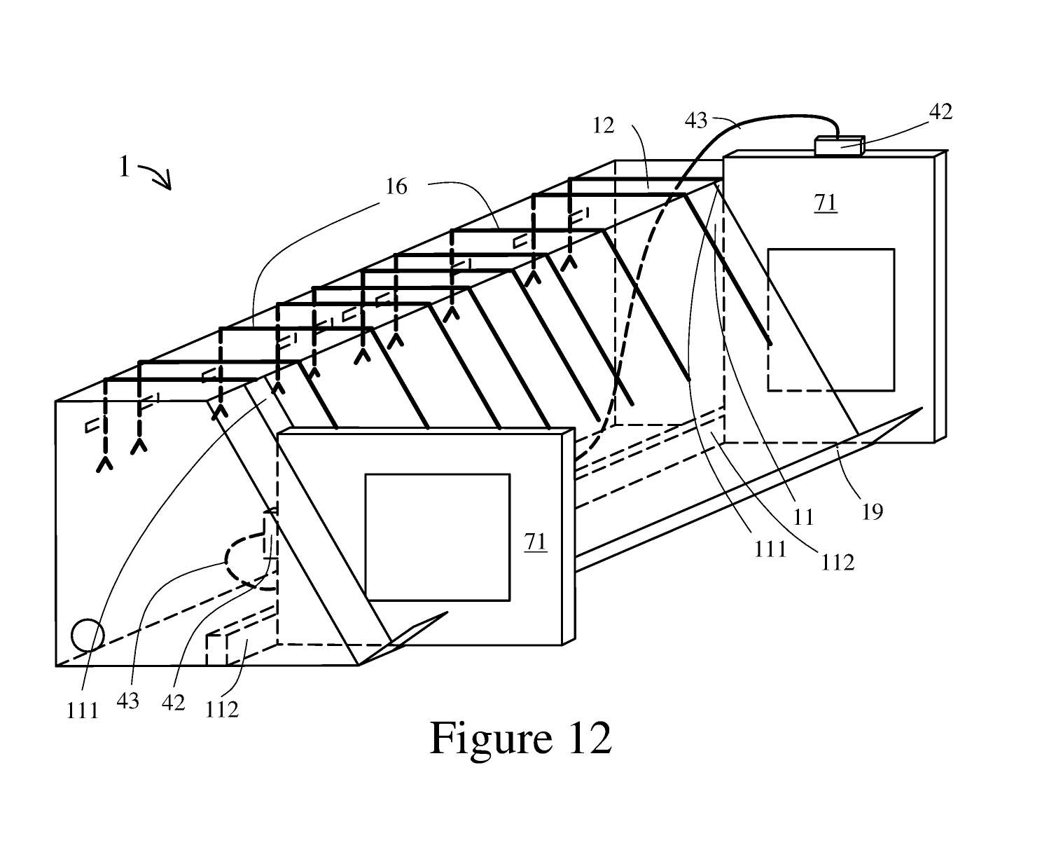

These devices 71 may reside and be charged either on the top shelf 12 or upon the slanted front surface 11 depending on space considerations and whether the device is to be only charged, or used while charging. In general, external hard drives are placed on front slanted surface 11, digital cameras on the top surface 12 or slanted front surface 11, and MP3 players like iPods on the top shelf top surface 12. Smart phones that are placed on their side along the slanted front surface 11 can be used while they are charging. To facilitate this, it may be desirable to optionally extend one or more of the cable slots 16 which terminate approximately 3″ above the bottom of front surface 11, to terminate at a lower position perhaps 2″ or 1″ or even less than 1″ above the bottom. And, in general, smaller devices are placed on top shelf 12 while larger ones are placed on front slanted surface 11, see also FIGS. 11 and 12 to be discussed below as regards yet another alternative for particularly large devices 71.

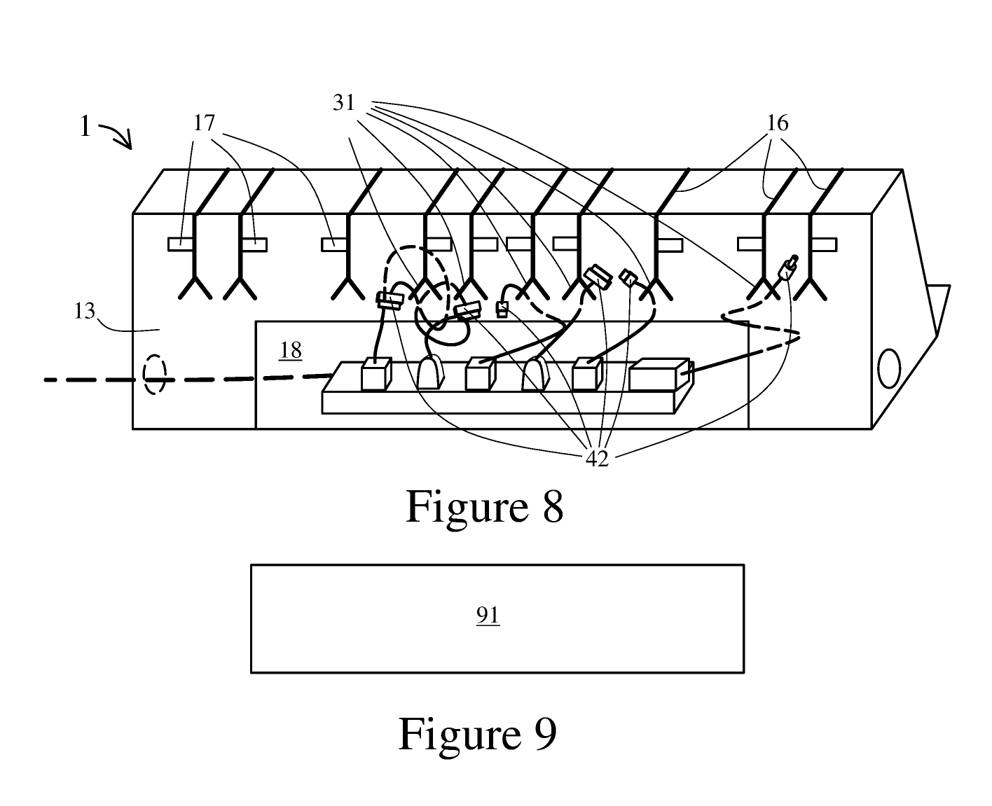

When a charging head 42 is not being used (i.e., when it is not connected to its associated electronic device 71) it can either be left in place, or allowed to slide all the way to the bottom (lowest extremity) of its slot 16 on the front slanted face 11 (Note: the slots 16 are dimensioned such that the charging heads are too large to fall through the slots 16). Preferably, however, turning now to FIG. 8, for a charging station 1 which is not wall mounted, the charging head 42 can be slid all the way to the backside of the unit and slid down beyond the charger head aperture 17 and parked at the bottom rear of the slot 16, or, as illustrated in FIG. 8, in the optional cable parking receptacle 31. The benefit of the “Y” configuration for cable parking receptacle 31, is that it neatly parks two cables per slot, whereas if it is omitted, one can neatly park only one cable per slot. Two cables per slot enables a single slot 16 to readily support both a device rested on the front surface 11 and the top surface 12. An inverted “W” (three prongs) rather than a “Y” can be used to enable three cables to be parked per slot, and other variations on this will be apparent to someone of ordinary skill and are regarded to be within the scope of this disclosure and its associated claims. In this way, the charging head 42 does not fall back inside the station 1, and both the charging head 42 and the cable 43 are hidden from view, in the rear of the station, when the cables are not plugged into their associated electronic device 71. The height of the cable parking receptacles 31 is chosen so that when station 1 is used on a countertop, the charging heads 42 can be parked (stored) at a height higher than customary countertops backsplashes so that the rear surface 13 of station 1 can be pushed right against a wall with some clearance above the backsplash. The illustration of charging heads of different shapes and sizes in FIG. 8 also highlights the unrestricted versatility and universality of charging station 1 to charge a virtually-unlimited variety of electronic devices 71.

FIG. 9 illustrates an optional access opening cover 91 which may be provided to fit over and mate and unmate with interior access opening 18 once all the wiring has been set up inside the station 1, so that all wiring is hidden from all views including the rear view. The mating and unmating enabling cover 91 to be attached and detached from opening 18 at will, may employ any manner of attachment devices and method knows in the art, including but not limited to various latches and snaps which are suitable for this purpose.

When it comes time to recharge a device 71, the charging head 42, assuming it has been stored/parked in the rear 13 as just discussed, is simply moved back into the desired position on the top 12 or front 11 surface, the head 42 is then plugged back into the associated device 71, and the device is then rested against charging station 1, returning to a configuration such as is illustrated in FIG. 7.

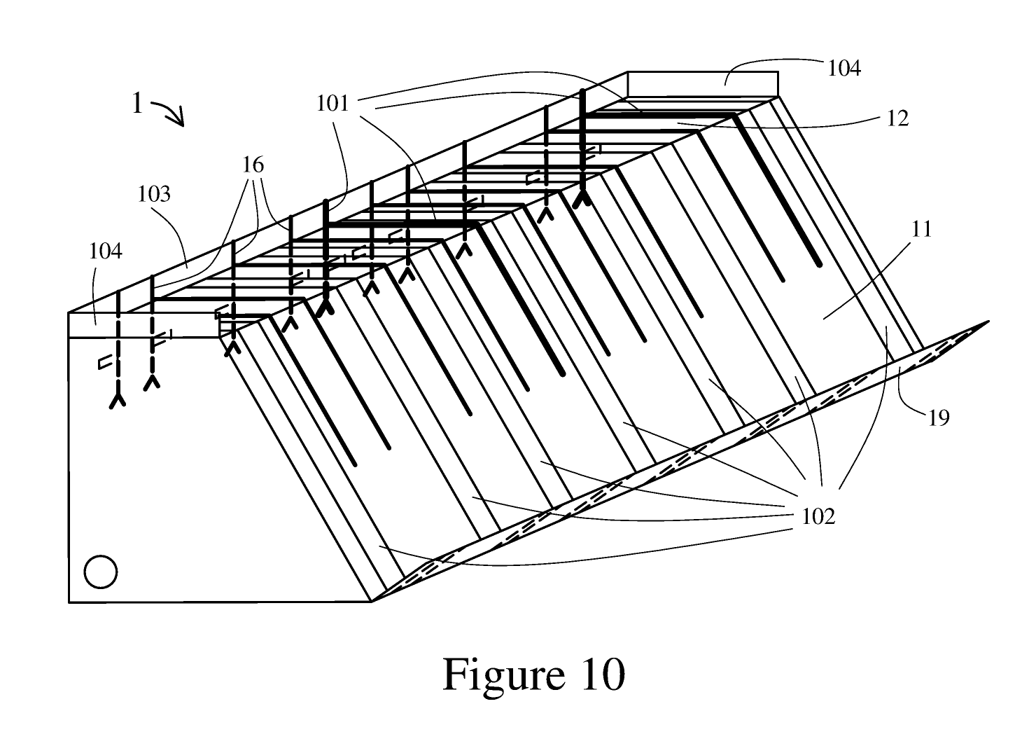

FIG. 10 illustrates a number of optional variations of the organizing and charging station 1, which enhance the flexibility and versatility and universality of this device, and/or which simply make station 1 easier to use. These variations may be employed individually, or in any desired combination, all within the scope of this disclosure and its associated claims.

First, to charge/use devices 71 which employ a standard (wider) power cord versus a device which uses a ⅛″ cord, FIG. 10 illustrates a variation in which station 1 comprises one or more extra-wide cable slots 101. These extra-wide cable slots 101 are of a dimension which allows them to accommodate such wider power cords, which cords are typically ¼″ or ⅜″ or even ⅝″.

Second, because working tablets generate substantially more heat than tablets which are merely charging but not running, FIG. 10 also illustrates one or more optional heat dissipation ribs 102 along the front surface 11 and optionally along the top surface 12, as illustrated. These ribs, which are about ⅛″ in height, run parallel with the cable slots to hold the devices 71 slightly elevated from the surface of station 1. As also shown via the hidden lines along front support shelf 19, these ribs 102 optionally, but preferably, also run along support shelf 19 as illustrated. Thus, when an electronic device 71 on the station 1 is running, the air space created by the ribs 102 will enable heat to be dissipated between the device 71 and the surface 11 and/or 12 of the station 1.

Third, a rear lip 103 running from side to side at the rear of the top surface 12 and/or similar side lips 104 running from front to rear along the sides of the top surface 12, are optionally provided to prevent an electronic device 71 from accidentally falling off the rear or side of the station 1 due to clumsiness by a user or other happenstance. In the case of rear lip 103, the cable slots 16 and extra-wide cable slots 101 of course extend to run through the lip, so that they do not block the fore and aft movement of the electrical connector wires 43 through these slots. The compressible retentive and protective material, mentioned in the earlier discussion, should preferably be added to these slot extensions through rear lip 103 as well, also to help protect the cable from damage such as cutting by contact with and movement against the edges of these slots 16 and 101.

FIG. 11 illustrates a variation of the station 1 of FIG. 1 comprising one or more electronic device slots 111, to be distinguished in configuration and use from the charging cable slots 16 which have been reviewed throughout much of this disclosure. These electronic device slots 111 run through substantially the entirety of front surface 11 between top and bottom, and also, preferably, through front support shelf 19, as illustrated. In conjunction with these electronic device slots 111, FIG. 11 also illustrates hidden within the interior of station 1, an optional device penetration barrier 112 running from side to side along the interior of the bottom surface plane 14, which device penetration barrier 112 is located substantially beneath the line at which front surface 11 meets top surface 12, as shown by the vertical reference line 113.

FIG. 12 now illustrates how the electronic device slots 111 combined with the optional device penetration barrier 112 of FIG. 11 may be used to store larger electronic devices 71, while charging (and possibly while in use, see earlier discussion of USB-type data connections), in a “folio” configuration. The wiring configuration is set up as previously discussed, and the electronic devices 71 are plugged in for charging, but now the electronic devices 71, particularly larger devices, are themselves placed upright into the electronic device slots 111 in the illustrated “folio” configuration, as opposed to being rested on the surface, contrast FIG. 7. FIGS. 11 and 12 illustrate two such electronic device slots 111 and two electronic devices 71 inserted into these slots, but this is non-limiting and the number of such electronic device slots 111 as well as the placement of such slots during manufacturing of station 1 can be varied as desired within the scope of this disclosure and its associated claims.

The electronic device 71 toward the upper right of FIG. 12 is illustrated to have been plugged in for charging, and then inserted “upside down” into its electronic device slot 111 with the charging head 42 and a small portion of connector wire 43 visible. In contrast, the electronic device 71 toward the lower left of FIG. 12 is illustrated to have been plugged in for charging, and then inserted into its electronic device slot 111 on its side, with the charging head 42 inside of station 1, entirely hidden from view.

Contrasting FIGS. 11 and 12, it may now be seen that each device 71 is substantially butted up against device penetration barrier 112, which barrier has as its purpose to limit a device 71 from being inserted too far back into electronic device slot 111 such that it disturbs the wiring. That is, the inserted electronic devices 71 rest forward of device penetration barrier 112, the wiring and power aggregation devices 51 sit behind device penetration barrier 112, and device penetration barrier 112 serve to largely separate the two. The height and width of this device penetration barrier 112 relative to the other aspects of FIG. 12 is illustrative only, and may readily be varied within the scope of this disclosure and its associated claims. For a device 71 which is placed into electronic device slot 111 such that its vertical dimension exceeds the height of station 1, as is the case for the device toward the upper right of FIG. 12, the juncture at which front surface 11 meets top surface 12 also serves in combination with device penetration barrier 112 to bar device 71 from being inserted too far, which is why optional device penetration barrier 112 is located substantially where front surface 11 meets top surface 12 as earlier illustrated and discussed in FIG. 11.

The orientation and position at which any individual device is placed into an electronic device slot 111 is wholly within the discretion of the user. In the variation where the electronic device slots 111 run through front support shelf 19 as illustrated, the electronic device 71 can be placed so as to extend (stick out) through front support shelf 19 and rest in part on the counter or other surface (not shown) upon which the station 1 is situated. This allows large notebook style devices to be charged and organized with station 1 as well, without being limited by the size of the station 1. Preferably, electronic device slots 111 also comprise a soft, protective material such as rubber or felt or sponge, so that electronic devices 71 are not scratched or cut when placed in and moved within electronic device slots 111.

These electronic device slots 111, by allowing larger devices to be stored folio-style through front surface 11 but not through rear surface 12, free up a great deal of surface area on both the front and rear surfaces 11 and 12, because the larger devices 71 do not consume such a large amount of space as in FIG. 7 and this space is then freed up for additional electronic devices 71. In other words, electronic device slots 111 serve to increase the capacity of station 1 to accommodate a larger number of electronic devices, by further optimizing the efficient utilization of space as among the front surface 11, the top surface 12, and the perpendicular storage relative to 11 and 12 offered by electronic device slots 111, thereby delivering a form of three-dimensional storage capacity based on 11, 12 and 111. Specifically, with electronic device slots 111, electronic devices 71 may be organized by station 1 in any of three dimensions defined by the plane of the slanted front surface 11, the plane of the top surface 12, and the plane created by insertion of a device into electronic device slot 111.

This charging station 1 disclosed in the foregoing embodiments and variation achieves multiple simultaneous objectives: First, the portable electronic devices 71 are neatly organized. Second, they are all plugged in to charge. Third, there is no limitation as to the size or shape or configuration or manufacturer or charging head configuration of the devices. The charging station 1 allows universal mixing and matching of multiple devices from multiple manufactures with any types of charging head configurations, see, e.g., the variety of charging heads illustrated in FIG. 8. This individual customization allows the user to physically lay out all of their devices on the station 1 in the best possible use of space/configuration for that particular user, and then thread the cables into and through the appropriate slots. Fourth, any single device may be positioned anywhere the user wishes, without restriction. Fifth, all of the unsightly wiring is hidden from view. Sixth, when connecting and disconnecting individual devices, the user does not have to trace through a jumble of wiring. Rather, the station hides all wires in an easily retrievable position when device is not plugged in. Seventh, using the folio variation of FIGS. 11 and 12, one can achieve a substantial increase in the available surface on the top and front surface of station 1, because a larger device that is stored in this way does not use as much surface area, leaving room on the surface for other, additional devices. This provides a three-dimensional storage capacity. Eighth, in the folio embodiment the user can chose to store the device so that there is absolutely no external appearance of wires or charging heads, see the device so-stored in the lower-left of FIG. 12.

Additionally, station 1 allows for upside down tablet charging on the face of the unit, allowing the user to actually view the charging light, instantly recognizing the charging status without touching/moving the device. As noted, station 1 also enables external hard drives to be used while on the front shelf of the station 1. Also, it enables tablets and smart phones to be used while lying on their side on the front of the device. Finally, when an electronic device is disconnected, its charging head 42 and the wiring 43 immediately proximate the charging head 42 can readily be parked (stored) out of sight as shown in FIG. 8.

It is to be understood that the optional variations described in the foregoing may be used or not provided in the manufacturing of station 1, in whatever combinations of none, some, or all, are desired. Dimensions of station 1 may be varied within the scope of the disclosure and the claims. Dimensions, locations, numbers and types of slots may be varied, all within the scope of this disclosure and its associated claims.

The knowledge possessed by someone of ordinary skill in the art at the time of this disclosure, including but not limited to the prior art disclosed with this application, is understood to be part and parcel of this disclosure and is implicitly incorporated by reference herein, even if in the interest of economy express statements about the specific knowledge understood to be possessed by someone of ordinary skill are omitted from this disclosure. While reference may be made in this disclosure to the invention comprising a combination of a plurality of elements, it is also understood that this invention is regarded to comprise combinations which omit or exclude one or more of such elements, even if this omission or exclusion of an element or elements is not expressly stated herein, unless it is expressly stated herein that an element is essential to applicant's combination and cannot be omitted. It is further understood that the related prior art may include elements from which this invention may be distinguished by negative claim limitations, even without any express statement of such negative limitations herein. It is to be understood, between the positive statements of applicant's invention expressly stated herein, and the prior art and knowledge of the prior art by those of ordinary skill which is incorporated herein even if not expressly reproduced here for reasons of economy, that any and all such negative claim limitations supported by the prior art are also considered to be within the scope of this disclosure and its associated claims, even absent any express statement herein about any particular negative claim limitations.

Finally, while only certain preferred features of the invention have been illustrated and described, many modifications, changes and substitutions will occur to those skilled in the art. It is, therefore, to be understood that the appended claims are intended to cover all such modifications and changes as fall within the true spirit of the invention.

I claim:

1. A universal organizing and charging station apparatus for organizing and charging electronic devices, comprising:
a bottom surface plane which is substantially horizontal running from front to back and side to side, with a bottom surface depth thereof as measured from front to back;
a substantially vertical rear surface;
a top surface which is substantially horizontal running from front to back and side to side, with a top surface depth thereof as measured from front to back, wherein said top surface depth is smaller than said bottom surface depth;
a slanted front surface connecting a front of said bottom surface with a front of said top surface, wherein said front surface is so-slanted because said top surface depth is smaller than said bottom surface depth and said rear surface is substantially vertical;
left and right side surface planes;
said rear, top and front surfaces, and said bottom and left and right side surface planes, defining an interior of said station;
a plurality of charging cable slots originating on said rear surface, running vertically up said rear surface, continuing over said top surface from back to front, continuing down at least part of said slanted front surface, and terminating on said slanted front surface, for sliding an electrical connector wire of said charging cable therethrough;
a plurality of charger head apertures, one associated with each said slot, disposed upon said rear surface in continuous connection with the associated slot, for threading a charging head therethrough; and
an interior access opening between an exterior and said interior of said station, for setting up a wiring configuration of said station.

2. The apparatus of claim 1, at least one of said charging cable slots comprising a cable parking receptacle proximate its origination on said rear surface, for parking a cable charging head when the cable charging head is not connected to an electronic device associated therewith.

3. The apparatus of claim 1, said rear surface comprising said interior access opening thereon.

4. The apparatus of claim 1 further comprising a power aggregation device situated in said interior, capable of receiving a plug section of a charging cable for an electronic device, said power aggregation device comprising a power cord for connecting said power aggregation device to a power source.

5. The apparatus of claim 4, said power aggregation device further comprising data connectors capable of transmitting data between the electronic device and a computer when the plug section is connected to said power aggregation device, when the electronic device is connected to a charging head of the charging cable, and when the power cord is is connected to a power and data port of the computer.

6. The apparatus of claim 1, said charging cable slots comprising a retentive and protective material for retaining an electrical connector wire of a charging cable in position within said slots and protecting said connector wire from damage.

7. The apparatus of claim 1, wherein a slant angle of said slanted front surface is at most 45 degrees from vertical.

8. The apparatus of claim 1, wherein a slant angle of said slanted front surface is approximately 30 degrees from vertical.

9. The apparatus of claim 1, further comprising a front support shelf along at least part of a lower length of said slanted front surface, for supporting an electronic device resting on said front surface.

10. The apparatus of claim 1, further comprising at least one electronic device slot running through substantially an entirety of said top surface between front and back and substantially an entirety of said front surface between top and bottom, for storing an electronic device, while charging, in an upright “folio” orientation; wherein:
electronic devices may be organized by said station in any of three dimensions defined by the plane of said slanted front surface, the plane of said top surface, and the plane created by insertion of a device into said electronic device slot.

11. The apparatus of claim 10, further comprising a device penetration barrier running along the interior of said bottom surface plane, from side to side, located substantially beneath where said front surface meets said top surface, for limiting an electronic device placed into said electronic device slot from being inserted too far back into said electronic device slot.

12. The apparatus of claim 1, further comprising a plurality of heat dissipation ribs on one or both of said top surface and said slanted front surface, for allowing heat to be dissipated when an electronic device placed upon said station is running.

13. The apparatus of claim 1, further comprising a lip selected from the group consisting of: a rear lip running from side to side at the rear of said top surface; and at least one side lip running from front to rear along the sides of the top surface, for preventing an electronic device from accidentally falling off the rear or side of the station.

14. A method for organizing and charging electronic devices using a universal organizing and charging station, comprising,
a) setting up a wiring configuration of said station for use via an interior access opening between an exterior and an interior of said station, by:
providing a power aggregation device situated in said interior, said interior defined by rear, top and front surfaces of said station, and by bottom, left and right side surface planes of said station;
connecting said power aggregation device to a power source;
plugging a plug section of a charging cable into a power outlet of said power aggregation device;
moving a charging head of said charging cable into said interior of said station; and
threading said charging head through a charger head aperture situated on said rear surface of said station, from said interior to an exterior of said station; and
b) using said station by:
if the electronic device associated with said charging cable is to be charged on said top surface, sliding an electrical connector wire of said charging cable through a charging cable slot of said station from said rear to said top surface of said station;
if the electronic device associated with said charging cable is to be charged on said front surface, sliding said electrical connector wire through said charging cable slot from said rear to said top surface of said station, and further to said front surface of said station;
providing charging power to said electronic device by plugging said charging head into the electronic device associated with said charging cable;
if the electronic device associated with said charging cable is to be charged on said top surface, resting said electronic device on said top surface; and
if the electronic device associated with said charging cable is to be charged on said front surface, resting said electronic device on said front surface; wherein:
said bottom surface plane is substantially horizontal running from front to back and side to side, with a bottom surface depth thereof as measured from front to back;
said rear surface is substantially vertical;
said top surface is substantially horizontal running from front to back and side to side, with a top surface depth thereof as measured from front to back, wherein said top surface depth is smaller than said bottom surface depth;
said front surface is slanted, connecting a front of said bottom surface with a front of said top surface, wherein said front surface is so-slanted because said top surface depth is smaller than said bottom surface depth and said rear surface is substantially vertical; wherein:
said station comprises a plurality of said charging cable slots, each said slot originating on said rear surface, running vertically up said rear surface, continuing over said top surface from back to front, continuing down at least part of said slanted front surface, and terminating on said slanted front surface; and
said station further comprises a plurality of said charger head apertures, one associated with each said slot, disposed upon said rear surface in continuous connection with the associated slot.

15. The method of claim 14, further comprising:
setting up said wiring configuration for at least two different electronic devices;
plugging the charging head for each of said electronic devices into said devices; and
resting said electronic devices upon said surface while connected to their charging cables such that for each of said electronic devices, no more than one inch of said charging cable extends to said exterior of said station.

16. The method of claim 14, further comprising, placing the electronic device in its intended location at its intended orientation upon said station, to guide said setting up said wiring configuration.

17. The method of claim 14, further comprising, when said electronic device is not being charged:
sliding said electrical connector wire through the charging cable slot in which it is situated, to the rear surface of said station; and
parking said charger head on the rear surface at the bottom of said charging cable slot.

18. The method of claim 14, further comprising, when said electronic device is not being charged:
sliding said electrical connector wire through the charging cable slot in which it is situated, to the rear surface of said station; and
parking said charger head in a cable parking receptacle at the bottom of said cable slot proximate said slot's origination on said rear surface.

19. The method of claim 14, further comprising:
connecting said power aggregation device to a power source simultaneously with establishing data connectivity with a computer, by plugging a feed cord of said power aggregation device into a computer port providing both power and data connectivity;
providing data connectivity between said electronic device and said computer simultaneously with providing said charging power by plugging said charging head into said electronic device associated with said charging cable;
simultaneously using said electronic device to transmit data between said electronic device and said computer while said electronic device is charging and is resting upon said station, by virtue of said data connectivity between said electronic device and said computer; wherein:
said charging cable is configured to simultaneously provide power and data connectivity for electronic devices to which it is connected.

20. The method of claim 14, further comprising retaining an electrical connector wire of said charging cable in position within its charging cable slot and protecting said connector wire from damage, using a retentive and protective material as part of said charging cable slot.

21. The method of claim 14, further comprising resting said electronic device on said front surface at an angle at most 45 degrees from vertical, by virtue of a slant angle of said slanted front surface being at most 45 degrees from vertical.

22. The method of claim 14, further comprising resting said electronic device on said front surface at an angle of approximately degrees from vertical, by virtue of a slant angle of said slanted front surface being approximately 30 degrees from vertical.

23. The method of claim 14, for an electronic device resting on said front surface, supporting said electronic device upon a front support shelf along at least part of a lower length of said slanted front surface.

24. The method of claim 14, further comprising at least one electronic device slot running through substantially an entirety of said top surface between front and back and substantially an entirety of said front surface between top and bottom; wherein:
if the electronic device associated with said charging cable is to be charged in said electronic device slot, storing said electronic device, while charging, in an upright orientation in said electronic device slot;
electronic devices may thereby be organized by said station in any of three dimensions defined by the plane of said slanted front surface, the plane of said top surface, and the plane created by insertion of the device into said electronic device slot.

25. The method of claim 24, further comprising to limiting an electronic device placed into said electronic device slot from being inserted too far back into said electronic device slot, using a device penetration barrier running along the interior of said bottom surface plane, from side to side, located substantially beneath where said front surface meets said top surface.

26. The method of claim 14, further comprising allowing heat to be dissipated when an electronic device placed upon said station is running, using a plurality of heat dissipation ribs on one or both of said top surface and said slanted front surface.

27. The method of claim 14, further comprising preventing an electronic device from accidentally falling off the rear or side of the station, using a lip selected from the group consisting of: a rear lip running from side to side at the rear of said top surface; and at least one side lip running from front to rear along the sides of the top surface.

28. A method for organizing and charging electronic devices, comprising, for a plurality of electronic devices and their associated charging cables:
setting up a plurality of charging cables in an interior of a universal organizing and charging station, wherein any entangling of said charging cables cannot be viewed from an exterior of said station;
providing power to said charging cables from a power aggregation device in said interior;
threading charging heads of said charging cables through charger head apertures of said station, from said interior to an exterior of said station;
positioning said cable heads for use by moving them through elongated slots of said station, said slots originating on a rear surface of said station, continuing over a top surface of said station from back to front, continuing down at least part of a slanted front surface of said station, and terminating on said slanted front surface;
plugging said electronic devices into said cable heads;
resting said electronic devices while powered by said cable heads on said top and slanted front surfaces.

29. The method of claim 28, further comprising:
when they are not plugged into said electronic devices, moving said cables heads to said rear of said station, through said elongated slots.
